(19) United States
(12) Patent Application Publication
(10) Pub. No.: US 2009/0129939 A1
(43) Pub. Date: May 21, 2009

(54) Apparatus for thermal dissipation and retention of float

(75) Inventor: Steve Hampton, Mustang, OK (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Little Giant Pump Company, Oklahoma City, OK (US)

(21) Appl. No.: 11/985,503

(22) Filed: Nov. 15, 2007

(51) Int. Cl. F04B 49/04; H01H 35/18; H01H 36/00; F16B 1/00

(52) U.S. Cl. 417/40; 200/84 C; 403/24

(57) ABSTRACT

In an improved pump assembly having a fluid reservoir into which a stationary post extends, a sensor is supported by the post and a floating member is supported for travel between upper and lower portions of the post. A magnet is supported by the floating member, the sensor responding to the position of the magnet as the floating ring member moves along the post. A float retention member is detachably supported by the post to retain the floating member on the post, the floating member having a support ring with a plurality of inwardly extending spring members disposed to grip the end of the post. A heat exchanger is supported for absorbing a portion of the thermal energy created by the pump assembly.

### BACKGROUND OF THE INVENTION

1. Field of Invention

The present invention relates to the field of pump assemblies, and more particularly but not by way of limitation, to thermal dissipation and liquid level controllers for pump assemblies.

2. Discussion

In typical fluid handling pump assemblies in which electrical energy rotates a shaft to produce fluid movement much of the electrical energy is converted to thermal energy. Reciprocating piston pumps often lose performance efficiency with the rise of temperature of valves and stators. Such pump assemblies find frequent use in condensate removal systems that are located in living or work areas, and it is usually desirable to protect the surrounding environment from heat dissipation.

Limited attention has been given to the removal and proper disposal of thermal energy from such pumping assemblies. Some have encapsulated the motor in an epoxy that has limited thermal conductivity. This approach has found limited application as it simply emits a portion of the thermal energy into a larger surrounding area. But for the majority of pump installations, such as where a pump assembly is located in a stagnant air space, it is substantially true that there has been no efficient means for removal of thermal energy.

Among such pump assemblies are condensate pump assemblies that find many applications for the collection and disposal of condensate fluids. In general, the condensate fluid is collected in a reservoir in which a liquid level controller is located to signal a pump to discharge the liquid as collected. Both hollow and solid floats are utilized. In the former, hollow floats effect proper body density by encasement of an air space, and in the latter, the floats are made of a material having a density lower than that of the fluid being detected; in both constructions, the float is designed to rise with the level of the fluid.

In the current state of the art, switching schemes for signaling pump activation employ either a Hall effect sensor or a reed switch sensor. In both such devices a magnetic field is sensed by the sensing and switching electronics. The float contains a magnet that is positioned in the vertical plane at the level of the collected condensate fluid in the reservoir. An especially efficient and cost effective way to achieve this detection scheme is with the use of a cylindrically shaped float, commonly called a “donut float”, with a portion of the sensing electronics encased within a stationary post upon which the donut float rides as it is caused to move by the rise and fall of the fluid surface.

It is common practice to injection mold the stationary post to encase the electronics for protection from the condensate fluid, and to position the donut float on the post during assembly of the unit. However, usually there is no retention mechanism to maintain the donut float on the post, and it is frequently the case that the float falls aside during any disassembly of the unit, such as for cleaning or functional checking, and must be re-positioned onto the post for re-assembling the unit.

There is a need in pumping assemblies system for a cost effective means for the heat dissipation that occurs with typical electrical driven pumping systems, while also serving to secure the float level sensing means during assembly and disassembly. The present invention provides solutions to these needs.

### SUMMARY OF THE INVENTION

The present application provides a pump assembly having a fluid reservoir that a stationary post extends into. A sensor is embedded in the post and a floating member is supported for travel between upper and lower portions of the post. A magnet is supported by the floating member, and the sensor responds to the position of the magnet as the floating ring member moves along the post.

A float retention member is detachably supported by the post to retain the floating member on the post, the floating member having a support ring with a plurality of inwardly extending spring members disposed to grip the end of the post.

A heat exchanger is supported to absorb a portion of the thermal energy created by the pump assembly, and conduit means direct the fluid collected in the reservoir through the heat exchanger as the fluid is discharged.

The advantages and features of the present invention will be apparent from the following description when read in conjunction with the accompanying drawings and appended claims.

### BRIEF DESCRIPTION OF THE DRAWINGS

FIG. 1 is perspective view of a pump assembly constructed in accordance with the present invention.

FIG. 2 is a side elevational, partially cutaway view of a portion of a pump assembly showing a post supported float arrangement.

FIG. 3 is a side elevational, partial cutaway view of a portion of a pump assembly showing a post supported float arrangement with a retention fastener.

FIG. 4 is a perspective view of the float retention device of FIG. 3.

FIG. 5 is a partially cutaway view of a portion of a similar pump assembly to that of FIG. 1 and which is equipped for thermal dissipation.

FIG. 6 is a perspective view of the coolant fluid flow directing member of the pump assembly of FIG. 5.

FIG. 7 is a partially exploded view in perspective of a pump assembly illustrating the condensate flow through conduits.

FIG. 8 is another perspective view of a pump assembly showing a wrap around heat dissipation device.

### DESCRIPTION

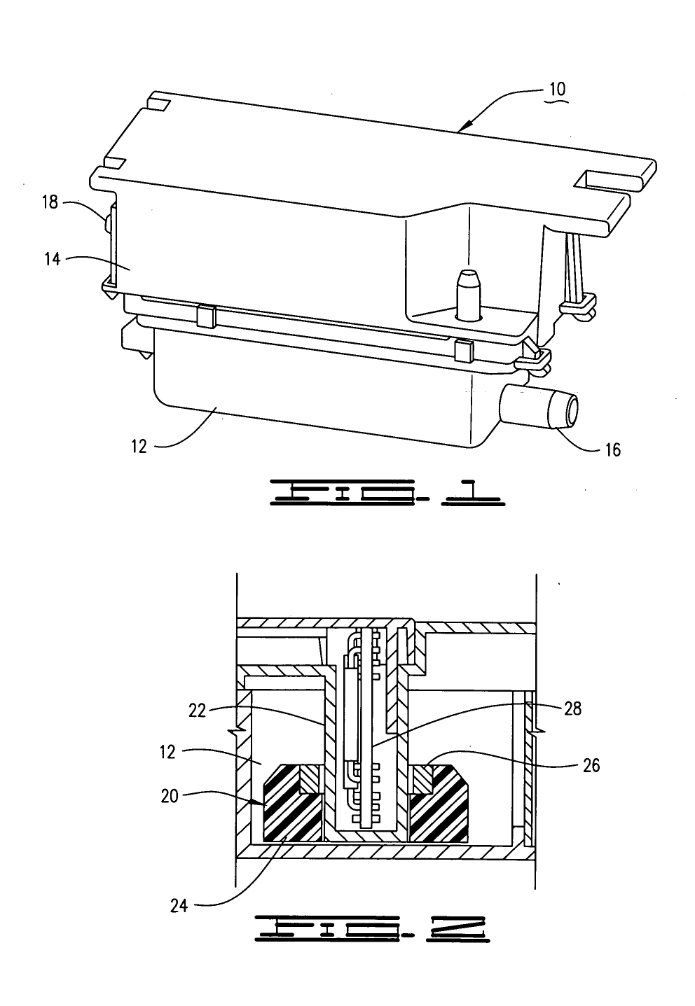

Referring to the drawings in general, and more particularly to FIG. 1, shown therein is a condensate pump assembly 10 having a reservoir compartment 12, a motor compartment 14, an inlet conduit 16 and a discharge conduit 18. FIG. 2, with the exception described below, is a partial cut away representation of a portion of the liquid level controller of the pump assembly 10.

Internal to the reservoir compartment 12 is a float assembly 20 that is disposed to slide along a stationary post 22, the post preferably having a substantially circular cross section and extending downwardly from the motor compartment 14 into the reservoir compartment 12. The float assembly 20 has a low density floating ring member 24 that is constructed of a material that will float on the surface of the condensate liquid that is accumulated in the reservoir compartment 12. For water systems, the ring member 24 can be constructed of a low density plastic, such as foamed plastics of various compositions. The ring member 24 has a central bore through which the post 22 extends.

In a preferred embodiment, a magnet ring member 26 is supported by the floating ring member 24, the magnet ring member 26 defining a central bore concentric with the central bore of the ring member 24, the stationary post 22 extending there through. As the level of liquid varies in the reservoir 12, the floating ring member 24 is caused to move along the post 22 between an upper portion of the post and a lower portion of the post, carrying the magnet ring with it. The material of the post 22 is selected to be transparent to magnet flux from the magnet ring 26; that is, the post 22 is of a non-magnet material, preferably a polymeric material that is molded. Internal to the post 22 is a detecting electronic sensor 28 of conventional design and preferably appropriately spaced apart detecting reed switches or hall effect sensors that respond to the magnet flux of the ring member 24 to activate an electric motor (not shown) in the motor compartment 14 that operates a pump (also in the motor compartment 14) to pump the liquid from the reservoir 12.

It will be appreciated by one skilled in the art that alternate embodiments of the present invention could be constructed that utilize various other conventional sensing technologies, such as inductive or capacitive sensors with appropriate materials attached to the floating ring member 24.

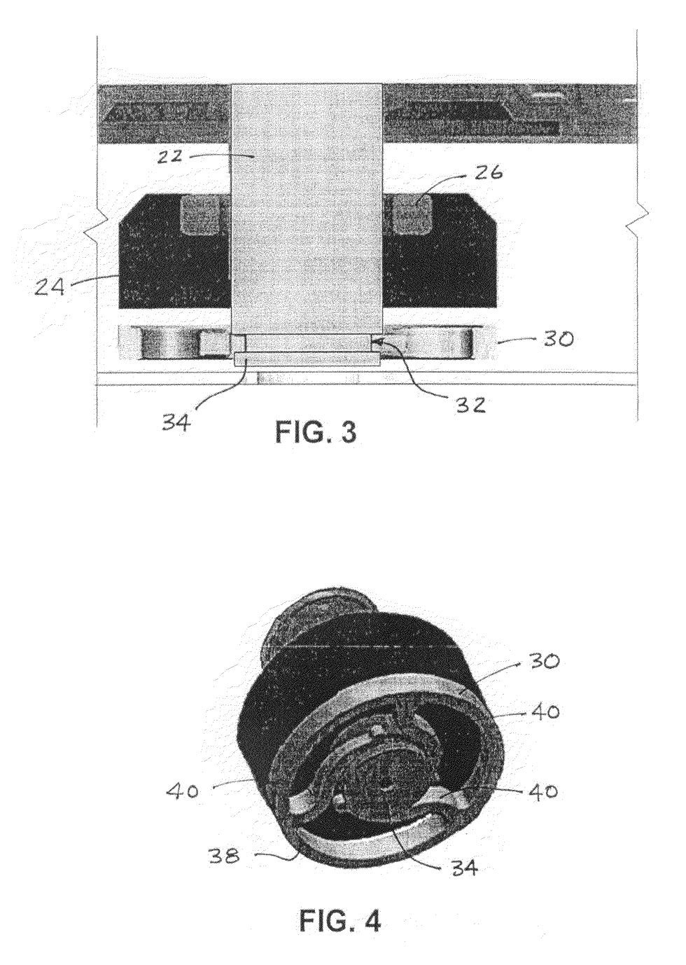

The exception noted above to the construction depicted in FIG. 2 is that the level controller of the pump assembly 10 is depicted in FIG. 3, in which the float assembly 20 is further defined as having a retention fastener 30. Another view of this feature is in FIG. 4. The post 22 has a nub 32 of reduced diameter at its lower end, and a stop member 34 is supported at the lower end of the nub 32 to form a locking groove 36 that is positioned in near proximity to the lower end of the post 22.

The retention fastener 30 has an outer support ring 38 that supports three curvi-linearly shaped spring fingers 40 that extend inwardly to have their ends disposable in the locking groove 36 to grip the nub 32. As depicted in FIGS. 3-4, the retention fastener 30 serves to retain the floating ring 24 on the post 22 and also as a lower stop for the floating ring 24.

In previous pump assemblies similar to that of the condensate pump assembly 10, prior to the provision of the retention fastener 30, limited attention was paid to the aligning problem incurred during assembly of the post 22 to the floating ring 24. It was normal to align the floating ring 24 on the post 22 as the parts were being assembled. Without the retention fastener 30, there was the difficulty of dropping the float during disassembly, often leading to contamination and potential breakage of the floating ring. With the retention fastener 30 in place, the floating ring 24 is secure during assembly and disassembly, maintaining the integrity of the components.

Removal of the floating ring 30 can easily be achieved by flexing the spring fingers 40 outwardly to clear the stop member 34. Once the retention fastener is removed, the floating ring 24 can be removed from the post 22; and in reassembling the components, once the floating ring 24 is positioned on the post 22, the spring fingers 40 are easily flexed to pass over the stop member 34, and inward flexing of the spring fingers 40 will readily seat in the locking groove 34, retaining the floating ring 24 in position.

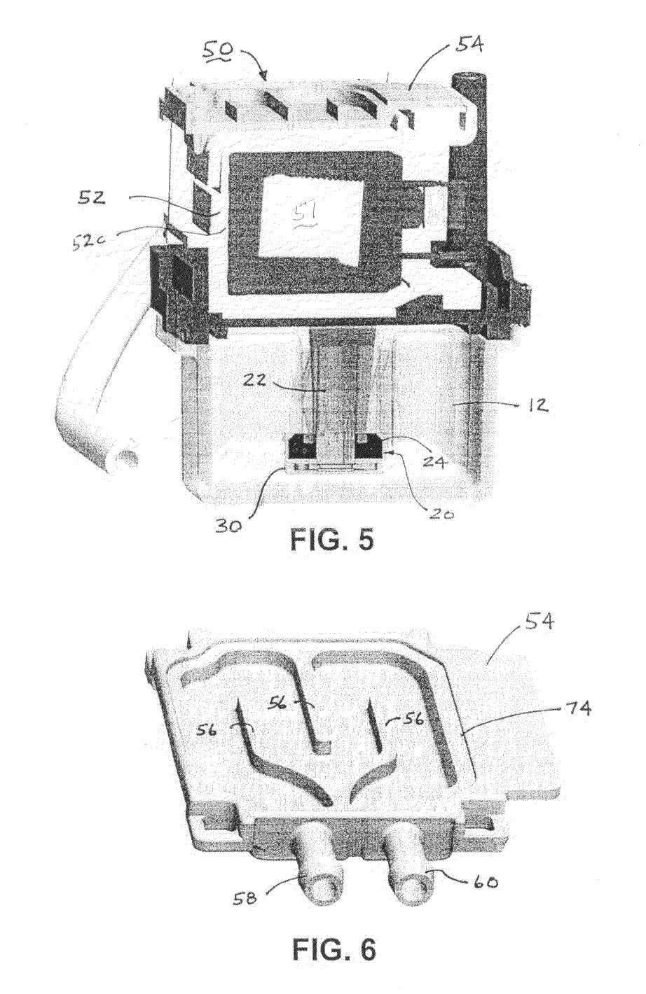

Turning to FIG. 5, a portion of a pump assembly 50 is depicted that is equipped for thermal energy dissipation in accordance with the present invention (and where applicable, the same numbers used to describe the pump assembly 10 will be utilized for describing the pump assembly 50). As is apparent, the pump assembly 50 is also equipped with the retention fastener 30 as shown. The pump assembly 50 has a pump 51 and a wrap around heat conducting layer 52 around the pump 51; in juxtaposition to the conducting layer 52 is a flow directing member 54, a view of which is in FIG. 6. The flow directing member 54 has a series of wall members 56 that, when enclosed by a top cover, as described below, defines a circuitous flow path that extends from a fluid inlet 58 to a fluid outlet 60.

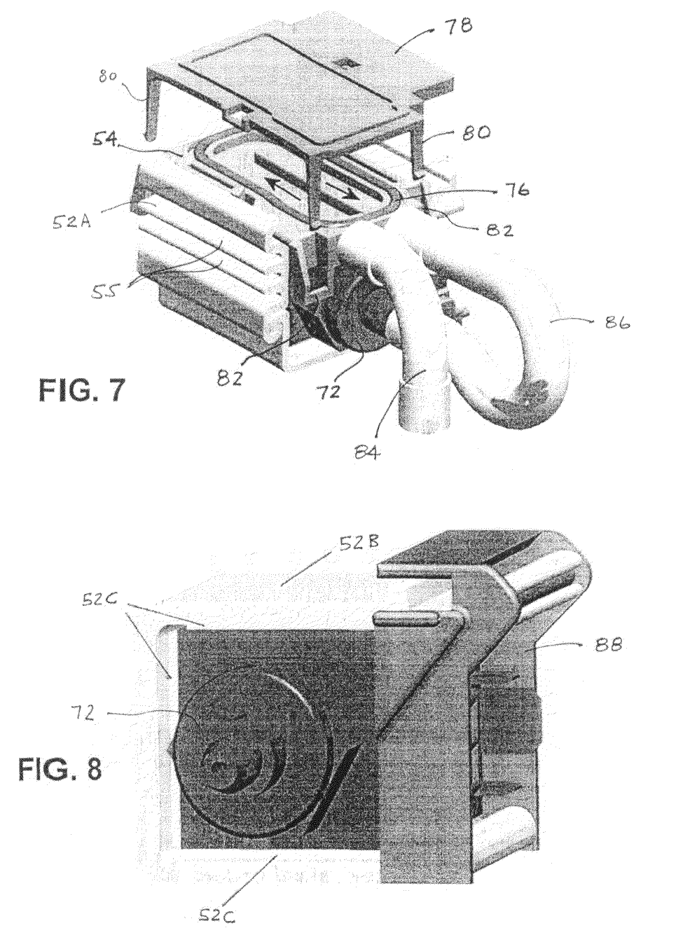

FIG. 7 depicts a pump assembly 70 that is a simplified version of the present invention (shown without the reservoir compartment 12, but it will be understood that such can be utilized therewith). The pump assembly 70 has a piston pump 72 (although the present invention is not limited to this type of pump) that has heat conducting wrap layer 52A.

As shown, the wrap around heat conducting layer 52A about the pump 51 has fins 55 that radiate a portion of the thermal energy created by operation of the pump 72. The flow directing member 54 is disposed against the wrap layer 52A, although the flow directing member 54 can be placed in direct contact with the exterior wall of the pump 72 if desired. Preferably, the flow directing member 54 is made of a heat conducting material, such as aluminum or a suitable plastic, as is the wrap layer 52.

The flow directing member 54 has a gasket groove 74 in which is disposed a gasket member 76. A cover member 78 is positioned over the flow directing member 54 and is locked in place by a series of locking tabs 80 and retaining members 82, thereby sealing against the gasket 76 to define the flow path in the heat exchanger thus formed. It should be noted that it may be desirable in some embodiments to eliminate the gasket 76 in the heat exchanger, and a preferred way to achieve this is to weld the cover 78 ultrasonically to the flow directing member 54 so that the wall members 56 are secured to the inner surface of the cover 78.

Arrows in FIG. 7 indicate the path of the cooling fluid as directed by the flow directing member 54 and cover member 78. A fluid such as water is pumped from a reservoir and is passed via a conduit 84 connected to the inlet 58, where the fluid passes through the length of the heat exchanger to flow back to discharge the outlet 60 into a conduit 86 that is connected to the inlet of the pump 72.

Since this type of pump can prime itself, it is able to pull the water from a reservoir and through the exchanger before pushing it out of the pump. The thermal energy, or heat, that is generated in the pump moves upward into the heat exchanger and into the fluid as it passes by. In most instances, this style pump will be pumping water at room temperature, and there will be an effective temperature differential to allow for the heat exchange. The thermal energy is carried off and dispersed over an area where it causes no problems. This process lowers the effective working temperature of the pump and improves reliability and life of parts as well as improving the flow capacity in many pumps.

Referring to FIG. 8, shown therein is the pump 72 that has been provided an external wrap layer 52B, which in this instance is a semi-rigid mounting structure. Sandwiched between the pump 72 and the rigid mounting structure 52B is a heat conducting layer 52C, which preferably is a silicone pad that is compliant enough to isolate vibrations from being transmitted to the mounting structure 52B. The mounting structure 52B preferably is an aluminum extrusion, as aluminum is one of the best heat conductors of common materials. The pad 52C is drawn taut by a conventional cinch connector 88.

The heat conducting layer 52C, extending around at least a portion of the pump, absorbs a portion of the thermal energy created by the pump and dissipating the thermal energy, and the compliant, heat conducting silicone pad 52C is preferably FUJIPOLY® Sarcon GR-b silicone material available from Fuji Polymer Industries, Co., LTD.

The thermal dissipation system depicted in FIG. 8, while isolating mechanical vibrations, conducts the heat into a much larger volume of material to remove it away from the pump 72. This allows for a large surface area to conduct/radiate the heat into the environment, reducing hot spots and lowering the effective working temperature of the pump, thereby improving reliability and minimizing parts wear, as well as improving the flow capacity.

It is clear that the present invention is well adapted to carry out the objects and to attain the ends and advantages mentioned as well as those inherent therein. While presently preferred embodiments of the invention have been described in varying detail for purposes of the disclosure, it will be understood that numerous changes may be made which will readily suggest themselves to those skilled in the art and which are encompassed within the spirit of the invention disclosed and as defined in the above text and in the accompanying drawings.

What is claimed is:

1. A liquid level float controller for a pump assembly having a fluid reservoir into which a post extends, comprising:
a sensor supported by the post;
a floating member moveable along the post;
a magnet supported by the floating member, the sensor responding to the position of the magnet as the floating ring member moves along the post; and
a float retention member attachable to the post, comprising:
a support ring; and
a plurality of inwardly extending spring members disposed to grip the end of the post.

2. The controller of claim 1 wherein the floating member comprises:
a ring member having a central bore through which the post extends, the floating member moveable between an upper portion and a lower portion of the post.

3. The controller of claim 2 wherein the post has a locking groove near the lower end thereof, the float retention member attachable with the spring members gripping the locking groove.

4. The controller of claim 3 wherein the post has a circular cross section and has a nub of reduced diameter at the lower end thereof, the post having a stop member supported by the nub to form the locking groove.

5. The controller of claim 1 wherein the pump assembly comprises:
a heat exchanger disposed in heat conducting relation to the pump;
means for passing the liquid collected in the reservoir through the heat exchanger to absorb thermal energy created by the pump.

6. The controller of claim 5 wherein the pump assembly further comprises:
a heat conducting layer surrounding a portion of the pump assembly for absorbing and radiating a portion of the thermal energy created by the pump.

7. The controller of claim 6 wherein the pump assembly further comprises:
a heat conducting layer extending around at least a portion of the pump assembly beneath the heat conducting layer, the heat conducting layer being compliant and isolating a portion of the vibrations created by the pump assembly.

8. The controller of claim 6 wherein the heat conducting layer is made of aluminum.

9. The controller of claim 8 wherein the heat conducting layer is a silicone material.

10. A pump assembly having a pump for pumping fluid from a fluid collection reservoir, a stationary post extending into the fluid collection reservoir, the pump assembly comprising:
a liquid level controller comprising:
a magnetically responsive sensor embedded within the stationary post;
a floating ring member slidingly moveable along the stationary post;
a magnet supported by the floating ring member, the sensor responding to the position of the magnet as the floating ring member moves along the stationary post; and
a detachable float retention member attachable to the end of the stationary post, the float retention member serving as a lower stop for the travel of the floating ring member on the stationary post; and
a heat exchanger disposed in heat conducting relation to the pump, the collecting fluid passing therethrough to absorb thermal energy created by the pump.

11. The pump assembly of claim 10 wherein the float retention member comprises:
a support ring; and
a plurality of inwardly extending spring members disposed to grip the end of the stationary post.

12. The pump assembly of claim 10 wherein the floating ring member has a central bore through which the post extends, the floating ring member moveable between an upper portion and a lower portion of the post.

13. The pump assembly of claim 12 wherein the post has a locking groove near the lower end thereof, the float retention member attachable with the spring members gripping the locking groove.

14. The pump assembly of claim 13 wherein the post has a circular cross section and has a nub of reduced diameter at the lower end thereof, the post having a stop member supported by the nub to form the locking groove.

15. The pump assembly of claim 10 further comprising:
means for passing liquid collected in the reservoir through the heat exchanger.

16. The pump assembly of claim 15 further comprising:
a heat conducting layer surrounding a portion of the pump assembly for absorbing and radiating a portion of the thermal energy created by the pump.

17. The pumps assembly of claim 16 further comprising:
a heat conducting layer extending around at least a portion of the pump assembly beneath the heat conducting layer, the heat conducting layer being compliant and isolating a portion of the vibrations created by the pump assembly.

18. The pump assembly of claim 17 wherein the heat conducting layer is made of aluminum.

19. The pump assembly of claim 18 wherein the heat conducting layer is a silicone material.

20. In a pump assembly having a pump and a fluid reservoir into which a stationary post extends, a sensor supported by the stationary post, a floating member restrained for movement along the stationary post and a magnetic member supported by the floating member, the sensor responding to the position of the magnetic member as the floating member moves along the stationary post, the improvement comprising:
float retention member attachable to the stationary post, comprising:
a support ring; and
a plurality of inwardly extending spring members disposed to grip the stationary post.

21. The improvement of claim 20 wherein the post has a locking groove near the lower end thereof, the float retention member attachable with the spring members gripping the locking groove.

22. The pump assembly of claim 21 wherein the post has a nub of reduced diameter at the lower end thereof, the post having a stop member supported by the nub to form the locking groove.

23. A liquid level float controller for a pump assembly having a fluid reservoir compartment in which a stationary post extends, comprising:
a floating ring member slidingly supported for movement along the stationary post;
a sensing material supported by the floating ring member;
a sensor embedded within the stationary post, the sensor responding to the position of the sensing material as the floating ring member moves along the stationary post; and
a float retention member removably attachable to the stationary post to retain the floating ring member on the stationary post, the float retention member comprising:
a support ring; and
a plurality of inwardly extending spring members disposed to grip the stationary post.
